(19) United States
(12) Patent Application Publication
(10) Pub. No.: US 2017/0238566 A1
(43) Pub. Date: Aug. 24, 2017

(54) COMPACT SMOKER

(71) Applicant: Spectrum Brands, Middleton, WI (US)

(72) Inventors: Jacob Daniel Smith, Monona, WI (US); Matthew Guckenberger, Oconomowoc, WI (US); Seth Sawyer, Middleton, WI (US)

(21) Appl. No.: 15/433,816

(22) Filed: Feb. 15, 2017

Related U.S. Application Data
(60) Provisional application No. 62/296,797, filed on Feb. 18, 2016.

(51) Int. Cl. A23B 4/052; A47J 37/07

(52) U.S. Cl. CPC A23B 4/052; A47J 37/0786; A23V 2002/00

(57) ABSTRACT

The smoker device disclosed herein provides a small profile device with more control than existing technologies for both cold smoking and smoking in an electric or compact grill. One of the main advantages of the design disclosed herein is a dual concentric or nesting fuel/housing dual structure that allows for adjusting the amount of smoke or aroma that a user wants the smoker device to emit during the smoking process.

### CLAIM OF PRIORITY

This application claims priority to and the benefit of a U.S. Provisional Application with Ser. No. 62/296,797, filed on Feb. 18, 2016, which is incorporated herein by reference in its entirety.

### FIELD AND BACKGROUND OF THE INVENTION

The present invention relates to a food preparation apparatus and more particularly to a smoking apparatus for adding flavor to grilled foods.

Devices commonly used to generate smoke for smoke curing or flavoring include burning suitable aromatic wood, or wood chips or pellets, such as on a tray in the presence of the food being grilled or with the charcoal briquettes or firewood if using natural fuel fires. Unfortunately, uncontrolled smoking fuel such as wood chips may ignite rather than smolder if they get too hot or are not wet enough when first used. Several methods of controlling the rate of burning have been utilized, such as wetting the smoking fuel with spray bottle or brief soaking before use. Wetting the fuel however may produce unsavory side effects while burning the smoking fuel in the presence of food may have unfavorable temperature effects, such as overcooking the food or changing its chemical structure (charred surfaces).

Accordingly, it is an advantage of the invention to provide a smoke-generating assembly which may generate smoke adjacent a suitably enclosed food cooking enclosure. It is another advantage of this invention to provide smoke-generating assembly that includes a method of controlling the rate of burning of the fuel and therefore the rate of smoke outflow.

These and other advantages shall become apparent from the description following, it being understood that modifications may be made without affecting the teachings of the invention here set out.

### SUMMARY

The various embodiments of the invention are directed to a compact pellet smoker assembly that facilitates curing or smoking in electric or compact grills or when grilling indoors or in close quarters. A compact pellet smoker that allows the user to control the amount of smoke output or extinguish the fuel pellets by varying the air flow would be advantageous. The device disclosed herein provides a small profile smoker device with more control than existing technologies for both cold smoking and smoking in an electric or compact grill. In various embodiments provided herein, concentric or nesting type configurations are provided that allow for adjusting the amount of smoke or aroma that a user wants the smoker device to emit during the smoking process. In one example embodiment, a dual concentric fuel/housing cylinder structure is provided that allows the user to move an inner housing structure up or down or to rotate relative to an outer housing that houses the inner structure (which holds the smoking or smoldering pieces) thereby adjusting the amount of smoke or aroma that a user wants the smoker device to emit (or not emit) during the smoking process.

In one example embodiment, a compact smoker assembly is provided that includes a porous cylindrical fuel chamber having a closed end and an open end, the fuel chamber configured to receive and retain particulate fuel, the fuel chamber having an inner portion structure configured to support a fuel starter element adjacent to particulate fuel in the fuel chamber. The smoker assembly further includes a cylindrical housing disposed concentrically about the cylindrical fuel chamber, an inner wall of the cylindrical housing configured to frictionally engage an outer wall portion of the cylindrical fuel chamber, the cylindrical housing configured to support the fuel starter element and the cylindrical fuel chamber within the housing. The smoker assembly also includes a cover member with an insulative member attached on an outer portion of the cover member, the cover member removably engageable with the open end of the fuel chamber and configured to facilitate exposure of part or all of the fuel chamber from the housing when a user engages the insulative member.

In another example embodiment, a compact smoker assembly is provided that includes an inner porous fuel chamber body having a closed end and an open end, the fuel chamber configured to receive and retain particulate fuel, the fuel chamber having an inner portion structure configured to support a fuel starter element adjacent to particulate fuel in the fuel chamber. The smoker assembly further includes a housing disposed about the inner fuel chamber body and configured to support the fuel starter element and support the fuel chamber within the housing. The smoker assembly also includes a cover member with a handle, the cover member removably engageable with the open end of the fuel chamber, the cover member configured to facilitate exposure of part or all of the fuel chamber from the housing when a user engages the handle. In a related embodiment, the inner wall of the housing and the outer wall portion of the fuel chamber body further comprise complementary threaded portions such that the user twists the insulative member of the cover member in an axial direction so as to rotate the fuel chamber body to partially or wholly expose the fuel chamber body and control an outflow of smoke from the housing. In yet another related embodiment, the inner wall of the housing and the outer wall portion of the fuel chamber body are configured to be engaged in one or more configurations to provide a range of smoking levels as a function of the outflow of smoke from the housing.

In yet another example embodiment, a compact smoker assembly is provided that includes an inner porous fuel chamber body having a closed end and an open end, the fuel chamber configured to receive and retain particulate fuel, the fuel chamber having an inner portion structure configured for receiving a fuel starter element for positioning adjacent to particulate fuel located in the fuel chamber body. The smoker assembly further includes a housing configured to be disposed concentrically about, or in a nesting relationship with, the inner fuel chamber. In a related embodiment, the closed end of the fuel chamber body includes an insulative member thereon configured to facilitate exposure of part or all of the fuel chamber body from the housing when a user engages the insulative member as a handle.

In a related embodiment, the housing includes a plurality of holes or pores configured to align with pores of the fuel chamber when the fuel chamber is rotated axially so as to allow smoke to be emitted from the housing in a range of smoking levels. The compact smoker assembly having an inner wall of the housing that is configured to frictionally engage an outer wall portion of the inner fuel chamber body, the housing being configured to support the fuel starter element and the fuel chamber body within the housing.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### DESCRIPTION OF THE DRAWINGS

Other important objects and advantages of the invention will be apparent from the following detailed description of the invention taken in connection with the accompanying drawings in which:

FIG. 1 illustrates a perspective view of one example embodiment of a smoker assembly according to the teachings herein;

FIG. 2 illustrates a partially exploded perspective view of a smoker assembly according to the teachings herein; and

FIG. 3 illustrates an exploded perspective view of a smoker assembly and method of using same according to the teachings herein.

### DETAILED DESCRIPTION OF THE INVENTION

The following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

In one example embodiment, a perforated metal cylinder forms an inner fuel chamber or housing containing smoking pellets which is surrounded by a secondary solid cylinder or outer housing. The outer housing includes a cover or cap to contain the inner housing. When the inner housing is fully surrounded by the outer housing and the cover, no air flow is allowed thus smoking is discontinued and the pellets start extinguishing. When the user separates the inner fuel chamber or cylinder from the outer housing or cylinder by a pulling or twisting motion, air flow is allowed through the fuel pellets or chips allowing them to either be lit or continue to smolder and emit smoke. The amount of separation between the perforated (porous) inner cylinder and the outer housing controls the amount of perforation (or number of pores) exposed and the amount of air flow, thereby controlling the amount of emitted smoke. In related embodiments, the inner housing and outer housing are rectangular (or square or spherical) structures which fit concentric to each other and optionally have a friction fit to allow partial or whole exposure of the inner housing that contains the combustible fuel when the inner fuel chamber or housing is pulled up or out or rotated in an axial direction to allow the aroma to be emitted from the device.

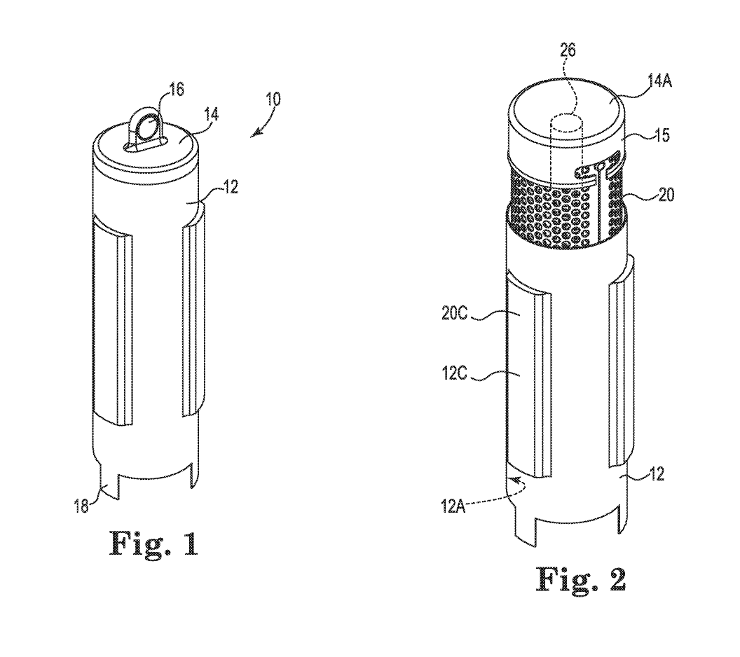

Referring now to the figures, FIGS. 1-3 illustrate a perspective, partially exploded and exploded views, respectively, of a smoker assembly 10 of the invention described herein. In particular, a compact smoker assembly 10 includes an inner porous or perforated cylindrical fuel chamber 20 having a closed (or partially closed) end 22 and an open end 24, the fuel chamber being configured to receive and retain a particulate fuel (such as wood pellets or chips; not shown). Fuel chamber 20 has an inner portion structure 26 configured to support a fuel starter element 30 adjacent to the particulate fuel that is placed in fuel chamber 20. Smoker assembly 10 also includes a cylindrical housing 12 disposed concentrically about inner cylindrical fuel chamber 20. In this example embodiment, an inner wall 12A of housing 12 is configured to frictionally engage an outer wall portion 20A of inner cylindrical fuel chamber 20. Cylindrical housing 12 is further configured to support fuel starter element 30 and fuel chamber 20 within housing 12.

Smoker assembly 10 further includes a cover member 14 with an insulative member 16 that is removably engageable (with a locking assembly 15) with open end 24 of fuel chamber 20 and an open end 12B of housing 12. In a related embodiment, member 16 need not be insulated and can simply have a handle or hook for grasping with another tool. In this example embodiment, cover member 14 is configured to facilitate exposure of part or all of fuel chamber 20 from housing 12 when a user engages or pulls on insulative member 16. In one example for controlling smoke output or outflow from smoker assembly 10, the user pulls or pushes insulative member 16 of cover member 14 to partially or wholly expose fuel chamber 20, thereby controlling the outflow of smoke from smoke assembly 10. When the user wants to inhibit or stop the smoke altogether cover member 14 is coupled (or closed) with housing 12, which stops outflow of smoke from housing 12 of the smoker assembly. Closing housing 12 with cover member 14 can also extinguish the burning fuel pellets or wood chips in the fuel chamber due to the lack of oxygen, thereby preserving the fuel pellets for another occasion. In an another example embodiment, an inner wall of housing 12 and an outer wall portion of fuel chamber 20 are configured to be engaged in one or more configurations with respect to each other to provide a range of smoking levels (from none to high) as a function of the outflow of smoke from housing 12 of the smoke assembly.

In another example embodiment for controlling smoke outflow, inner wall 12A of housing 12 and outer wall portion 20A of fuel chamber 20 further include complementary threaded portions 12C/20C such that the user twists insulative member 16 of cover member 14 in either direction so as to rotate fuel chamber 20 to partially or wholly expose fuel chamber 20 and control an outflow of smoke from housing 12. In this example embodiment, housing 12 includes (downwardly) protruding flanges 18 at a closed end of housing 12 opposite cover member 14. In a related embodiment, a threaded screw comes up from the closed or bottom end of the inside of housing 12 and engages a threaded hole in the bottom of fuel chamber 20 to secure chamber 20 within housing 12 and facilitate a twisting-out motion of fuel chamber 20 to expose the pores of the fuel chamber.

In yet another example embodiment, inner fuel chamber 20 and outer housing 12 are formed with partial perforated surfaces such that rotating inner chamber 20 in one direction aligns the pores of the perforation of inner fuel chamber 20 with the pores/holes (not shown) on outer housing 12 and emit the smoke. In this example embodiment, when inner chamber 20 is rotated in the opposite direction (or is turned further in the original direction) the pores in both cylinders are no longer aligned and the pellets are closed from receiving air and emitting smoke. With this approach, the inner fuel chamber or cylinder need not be pulled up or twisted out of housing 12 in order to emit the smoke and with this configuration smoke is emitted from housing 12 in a range of smoking levels desired by the user.

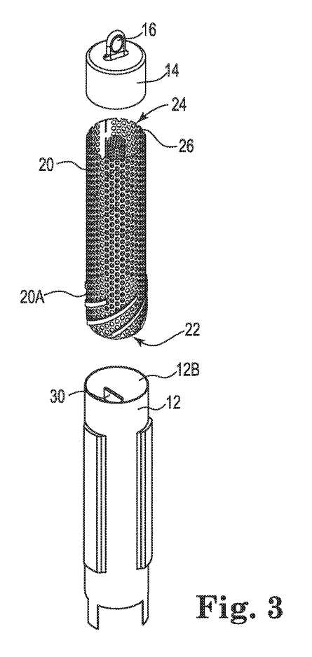

Referring more particularly to FIG. 3, there is illustrated a method of using smoker assembly 10. The user first inserts fuel starter 30 (arrow 1) within housing 12 and then fuel chamber 20 is then filled with fuel pellets or chips (arrow 2). Fuel chamber 20 is then inserted into housing 12 over fuel starter 30 such that the fuel starter is disposed adjacent the fuel pellets sufficiently to ignite the wood fuel pellets when the fuel starter is lit. Fuel starter 30 is not limited to a rod structure and can be a strip or can be added into the internal cylinder 26 after fuel chamber 20 is inserted into housing 12. After lighting the fuel starter, cover member 14 if placed on fuel chamber 20 and optionally locked in to permit pulling or twisting (using insulative tab 16) of fuel chamber 20 during use of the smoker assembly to control the amount of smoke emitted.

In various embodiments, housing 12 is formed from or made of different types of heat resistant metals or ceramics and fuel chamber 20 is formed from or made of different types of heat resistant metals or ceramics. Insulative materials described herein include heat resistant plastics and ceramics.

The following patents and publications are incorporated by reference in their entireties: U.S. Pat. Nos. 4,770,157; 5,048,406; and 2013/0011535.

The foregoing specific embodiments of the present invention as set forth in the specification herein are for illustrative purposes only. Various deviations and modifications may be made within the spirit and scope of the invention without departing from the main theme thereof.

What is claimed is:

1. A compact smoker assembly comprising:
a porous cylindrical fuel chamber having a closed end and an open end, the fuel chamber configured to receive and retain particulate fuel, the fuel chamber having an inner portion structure configured to support a fuel starter element adjacent to particulate fuel in the fuel chamber;
a cylindrical housing disposed concentrically about the cylindrical fuel chamber, an inner wall of the cylindrical housing configured to frictionally engage an outer wall portion of the cylindrical fuel chamber, the cylindrical housing configured to support the fuel starter element and the cylindrical fuel chamber within the housing; and
a cover member with an insulative member attached on an outer portion of the cover member, the cover member removably engageable with the open end of the fuel chamber and configured to facilitate exposure of part or all of the fuel chamber from the housing when a user engages the insulative member.

2. The smoker assembly of claim 1 wherein the user pulls or pushes the insulative member of the cover member to partially or wholly expose the fuel chamber and control an outflow of smoke from the cylindrical housing.

3. The smoker assembly of claim 1 wherein the inner wall of the cylindrical housing and the outer wall portion of the fuel chamber further comprise complementary threaded portions such that the user twists the insulative member of the cover member in an axial direction so as to rotate the fuel chamber to partially or wholly expose the fuel chamber and control an outflow of smoke from the cylindrical housing.

4. The smoker assembly of claim 1, wherein the cover member is engaged with the housing to inhibit outflow of smoke from the cylindrical housing.

5. The smoker assembly of claim 1, wherein the cylindrical housing includes downwardly protruding flanges at a closed end of the cylindrical housing opposite the cover member.

6. A compact smoker assembly comprising:
an inner porous fuel chamber body having a closed end and an open end, the fuel chamber configured to receive and retain particulate fuel, the fuel chamber having an inner portion structure configured to support a fuel starter element adjacent to particulate fuel in the fuel chamber;
a housing disposed about the inner fuel chamber body and configured to support the fuel starter element and support the fuel chamber within the housing; and
a cover member with a handle, the cover member removably engageable with the open end of the fuel chamber, the cover member configured to facilitate exposure of part or all of the fuel chamber from the housing when a user engages the handle.

7. The compact smoker assembly of claim 6, wherein an inner wall of the housing is configured to frictionally engage an outer wall portion of the inner fuel chamber body, the housing configured to support the fuel starter element and the fuel chamber body within the housing.

8. The compact smoker assembly of claim 6, wherein the handle of the cover member comprises an insulative handle member affixed thereon.

9. The compact smoker assembly of claim 8, wherein the user pulls or pushes the insulative member of the cover member to partially or wholly expose the fuel chamber and control an outflow of smoke from the housing.

10. The compact smoker assembly of claim 6, wherein the inner wall of the housing and the outer wall portion of the fuel chamber body further comprise complementary threaded portions such that the user twists the insulative member of the cover member in an axial direction so as to rotate the fuel chamber body to partially or wholly expose the fuel chamber body and control an outflow of smoke from the housing.

11. The compact smoker assembly of claim 6, wherein the inner wall of the housing and the outer wall portion of the fuel chamber body are configured to be engaged in one or more configurations to provide a range of smoking levels as a function of the outflow of smoke from the housing.

12. The compact smoker assembly of claim 9, wherein the cover member is engageable with the housing to inhibit outflow of smoke from the housing.

13. The compact smoker assembly of claim 10, wherein the cover member is coupled with the housing to inhibit outflow of smoke from the housing.

14. The smoker assembly of claim 6, wherein the housing includes protruding flanges at a closed end of the housing opposite the cover member, the flanges providing a support base for the smoker assembly.

15. The smoker assembly of claim 6, wherein the housing includes a plurality of holes or pores configured to align with the pores of the fuel chamber when the fuel chamber is rotated axially so as to allow smoke to be emitted from the housing.

16. The smoker assembly of claim 11, wherein the housing includes a plurality of holes or pores configured to align with the pores of the fuel chamber when the fuel chamber is rotated axially so as to allow smoke to be emitted from the housing in a range of smoking levels.

17. A compact smoker assembly comprising:
an inner porous fuel chamber body having a closed end and an open end, the fuel chamber configured to receive and retain particulate fuel, the fuel chamber having an inner portion structure configured for receiving a fuel starter element for positioning adjacent to particulate fuel located in the fuel chamber; and
a housing configured to be disposed concentrically about, or in a nesting relationship with, the inner fuel chamber.

18. The smoker assembly of claim 17, wherein the closed end of the fuel chamber body includes an insulative member thereon configured to facilitate exposure of part or all of the fuel chamber from the housing when a user engages the insulative member as a handle.

19. The smoker assembly of claim 17, wherein the housing includes a plurality of holes or pores configured to align with pores of the fuel chamber when the fuel chamber is rotated axially so as to allow smoke to be emitted from the housing in a range of smoking levels.

20. The compact smoker assembly of claim 17, wherein an inner wall of the housing is configured to frictionally engage an outer wall portion of the inner fuel chamber body, the housing configured to support the fuel starter element and the fuel chamber body within the housing.
